(19) United States
(12) Patent Application Publication
(10) Pub. No.: US 2015/0293743 A1
(43) Pub. Date: Oct. 15, 2015

(54) WATERMARK LOADING DEVICE AND METHOD

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventor: PENG YANG, Shenzhen (CN)

(21) Appl. No.: 14/486,437

(22) Filed: Sep. 15, 2014

(30) Foreign Application Priority Data
Apr. 11, 2014 (CN) 2014101453085

(51) Int. Cl. G06F 3/16; G05B 15/02

(52) U.S. Cl. CPC G06F 3/165; G05B 15/02

(57) ABSTRACT

A watermark loading device loads watermark to an original audio. The watermark loading device preprocesses the original audio to calculate a volume and a pitch of the original audio and saves the volume and the pitch as audio information of the original audio. The watermark loading device configures relevant parameters of watermark loading including a watermark loading intensity, a volume threshold and a pitch threshold used for choosing a target fragment of the original audio that is to be loaded watermark. The watermark loading device compares the audio information with the volume threshold and the pitch threshold to determine the target fragment and loads watermark for the target fragment according to the watermark loading intensity to get a watermarked audio.

### FIELD

Embodiments of the present disclosure generally relate to audio processing technology, and more particularly to a watermark loading device that can load watermark for audio file and method of loading watermark.

### BACKGROUND

In many technical fields, it is often necessary to add some information to media files (audio, video, images, etc.) to acts as tag information or to protect media files, but the adding information is generally hidden and is not perceived by the user. For such added information, it is usually called as “Watermark”. For audio, video or image files, some purpose can be achieved by loading appropriate watermark. Watermarks should not affect the quality of the original media files and that the media files should have good robust features and can resist compression after loading watermark.

It is desirable to provide a watermark loading device that can load a watermark for audio file and method of loading watermark to solve the problems mentioned above.

### BRIEF DESCRIPTION OF THE DRAWINGS

FIG. 1 is a block diagram of functional units of a watermark loading device of one embodiment.

FIG. 2 is a flowchart of one embodiment of a method of loading a watermark to an original audio.

FIG. 3 is a flowchart of one embodiment of preprocessing an original audio, the flowchart gives details of block 200 in FIG. 2.

FIG. 4 is a flowchart of one embodiment of loading a watermark; the flowchart gives details of blocks 202 and 204 in FIG. 2.

FIG. 5 is a diagram of one embodiment of result of calculating a volume and a pitch of an original audio, showing an example of audio preprocessing.

FIG. 6 is a diagram of one embodiment of choosing target fragment of an original audio based on FIG. 5.

FIG. 7 is a diagram of one embodiment of comparison of audio files before and after watermark loading showing on MATLAB platform.

FIG. 8 is a diagram of one embodiment of comparison of watermarked audio files before and after compression showing on MATLAB platform.

### DETAILED DESCRIPTION

The embodiments herein are illustrated by way of example and not by way of limitation in the figures of the accompanying drawings, in which like reference numerals indicate similar elements. It should be noted that references to “an” or “one” embodiment in this disclosure are not necessarily to the same embodiment, and such references mean “at least one.”

In general, the word “unit,” as used hereinafter, refers to logic embodied in hardware or firmware, or to a collection of software instructions, written in a programming language such as, for example, Java, C, or assembly. One or more software instructions in the units may be embedded in firmware such as in an erasable-programmable read-only memory (EPROM). Units may comprise connected logic units, such as gates and flip-flops, and may comprise programmable units, such as programmable gate arrays or processors. The units described herein may be implemented as either software and/or hardware units and may be stored in any type of computer-readable medium or other computer storage device.

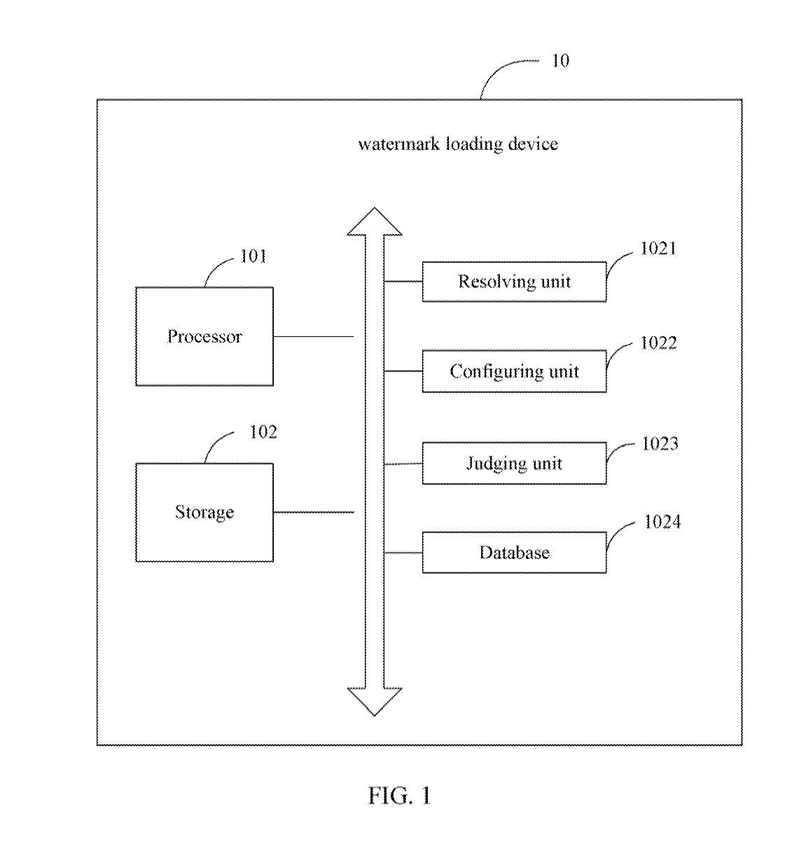

FIG. 1 is a block diagram of functional units of watermark loading device 10 of one embodiment. The watermark loading device 10 includes a resolving unit 1021, a configuring unit 1022, a judging unit 1023, a database 1024, at least one processor 101, and a storage system 102. The units 1021-1023 can include computerized code in the form of one or more programs that are stored in the storage system 102. The computerized code includes instructions that are executed by the at least one processor 101 to provide functions for the units 1021-1023. In at least one embodiment, the storage system 102 may include a hard disk drive, a flash memory, and a cache or another computerized memory device. In one embodiment, the watermark loading device 10 can be any codec or computers with digital processing and codec, which is not a limitation to the present disclosure.

The resolving unit 1021 preprocesses an original audio that is to be loaded a watermark. When an original audio is confirmed to be a loaded watermark, the resolving unit 1021 resolves the original audio and divides the original audio into a plurality of frames. The length of each frame of the original audio is decided by users. For each frame of the original audio, the resolving unit 1021 calculates the volume and the pitch of each frame one by one from the first frame to the last frame, and the calculated volume and pitch of each frame is stored into a cache in database 1024 located as calculated information of corresponding frames. Here, volume is used to measure the energy of the original audio while pitch is associated with the frequency of the original audio signal measured in units of Hz. Calculated information of each frame is stored in corresponding unit in the cache block recording as buffer (i), i=1,2,3 . . . etc., which is an example of record but not a limitation to the present disclosure.

The configuring unit 1022 configures relevant parameters of watermark loading. The configuring unit 1022 receives setting information input by users and presets the length of the watermark N, the watermark loading intensity SNR (single-noise-ratio) and the thresholds for target fragment determination according to the setting information received. In detail, the watermark loading intensity refers to a value of SNR of the watermarked audio and the preset value is the minimum value that a user can accept. For example, if a user expects that the absolute value of SNR of the watermarked audio is larger than 60, the configuring unit 1022 presets SNR=60 dB. In more detail, the thresholds include two threshold values, one is a volume threshold and the other is a pitch threshold.

The judging unit 1023 compares the calculated information of the original audio with the preset thresholds and determines the target fragment to load the watermark. In order to hide the watermark, a low-frequency fragment is chosen as target while the fragment is also a high-volume fragment, based on the human auditory masking effect as well as considering the energy of the signal. For example, if the volume threshold is 0.15V and the pitch threshold is 200 Hz, respectively, a frame is determined to be the target fragment when the pitch of the frame is lower than 200 Hz and the volume of the same frame is greater than 0.15V. Then, the judging unit 1023 loads watermark to the target fragment according to relevant parameters preset. The judging unit 1023 judges each frame of the original audio, one by one, to determine the target fragments and loads watermark to each target fragment until the length of the watermark reaches N as preset. In detail, the intensity of noise needed when loading a watermark is decide by the preset SNR (watermark loading intensity) and the preset thresholds, which needs to ensure that the value of the SNR of the watermarked audio reaches the value of the preset SNR. Meanwhile, the value of the volume threshold can be adopted as the actual volume of audio when calculating the intensity of noise so that the noise intensity is consistent. Also, Gaussian white noise can be a good choice because it is easy to analyze and easy to extract as well as will not bring too much irregular noise.

In general, masking refers to a sound affect another sound when the auditory system feeling sound and masking effect also exits in human auditory. The masking effect means that when the two sounds are transmitted simultaneously in one system, a weak sound becomes unable to be heard as a result of the existence of a stronger sound. It is a problem worthy of study and attention how to apply the masking effect to the watermark loading technique of media files to achieve a ends of hiding watermark based on masking effect.

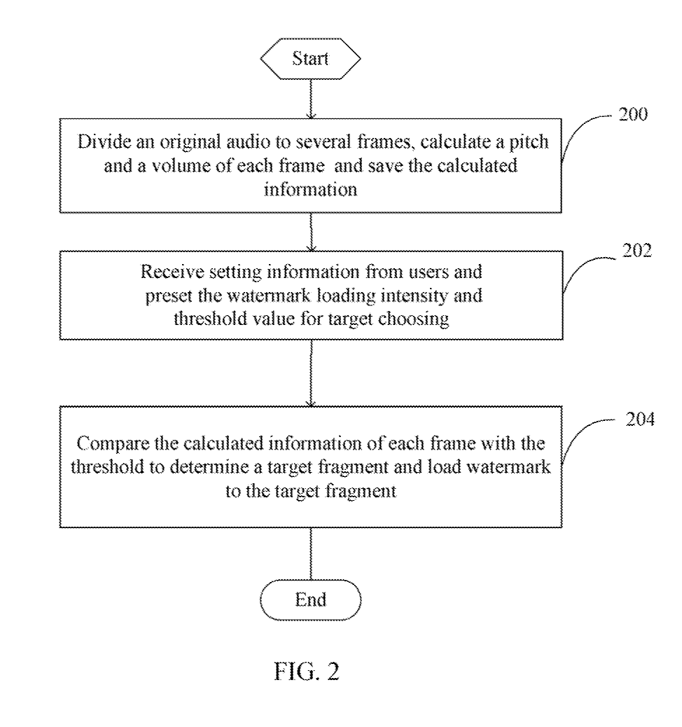

FIG. 2 illustrates a flowchart of one embodiment of a method of loading a watermark to an original audio. In the described embodiment, the method is executed by the units described in FIG. 1.

In block 200, the resolving unit 1021 resolves an original audio and divides the original audio into a plurality of frames. For each frame of the original audio, the resolving unit 1021 calculates a volume and a pitch of the frame, and the calculated volume and the calculated pitch of each frame is stored into the cache in database 1024 located as calculated information of corresponding frames.

In block 202, the configuring unit 1022 receives setting information input by the users and configures relevant parameters according to the setting information received. The relevant parameters include the length of the watermark N, the watermark loading intensity SNR (single-noise-ratio) and the thresholds for target fragment determination

In block 203 the judging unit 1023 compares the calculated information of the original audio, that includes volume and pitch, with the preset thresholds and determines the target fragment to load watermark, then loads the watermark to the target fragment.

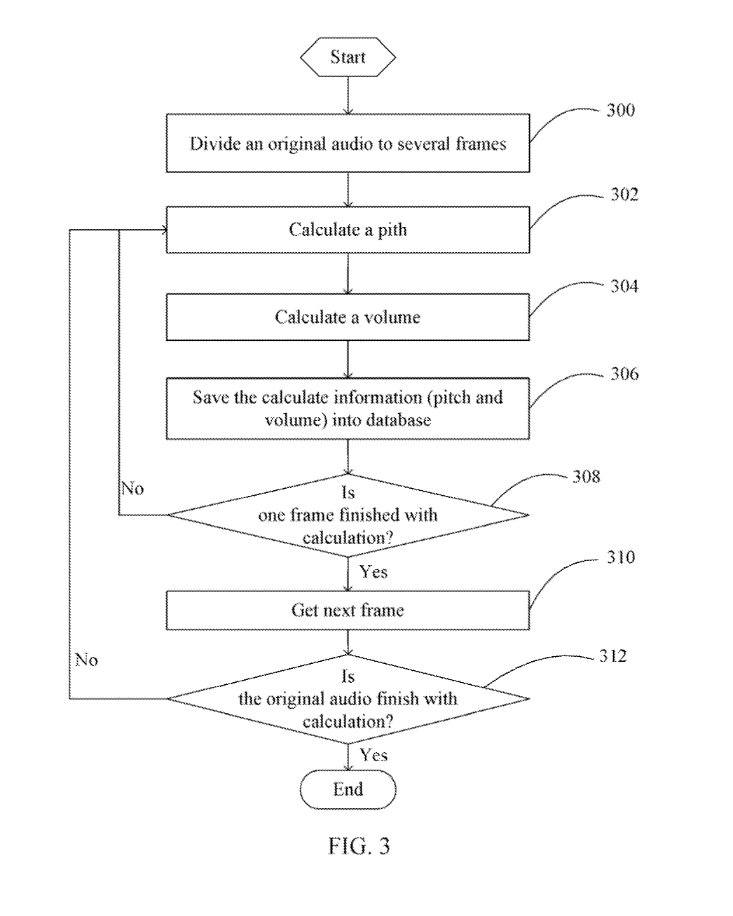

FIG. 3 illustrates a flowchart of one embodiment of preprocessing a original audio, the flowchart gives details of block 200 in FIG. 2. In the described embodiment, the method is executed by the units described in FIG. 1.

In block 300, when an original audio is confirmed to be loaded watermark, the resolving unit 1021 resolves the original audio, divides the original audio into a plurality of frames. The length of each frame is decided by the users.

In blocks 302 and 304, the resolving unit 1021 calculates the volume and the pitch of each frame one by one from the first frame to the last frame, and the calculated volume and the calculated pitch of each frame is stored into the cache in database 1024 located as calculated information of corresponding frames in block 306. Here, the volume is used to measure the energy of the original audio while pitch is associated with the frequency of the original audio signal measured in units of Hz. Each frames owns a block recording corresponding calculated information in the cache block, recording as buffer (i), i=1,2,3 . . . etc., which is an example of record but not a limitation to the present disclosure.

In block 308, the resolving unit 1021 determines whether one frame is finished with calculation. If the calculation of the frame is finished, then the flowchart goes to block 310 and the resolving unit 1021 get a new frame from the database to begin a new calculation for the next frame 1024. If the calculation of the frame is not finished yet, the flowchart goes to block 302 and the resolving unit 1021 continues calculating.

In block 312, the resolving unit 1021 determines whether the original audio is finished with calculation. If no, the flowchart goes back to block 302, the resolving unit 1021 continues calculating until the original audio is finished with calculation.

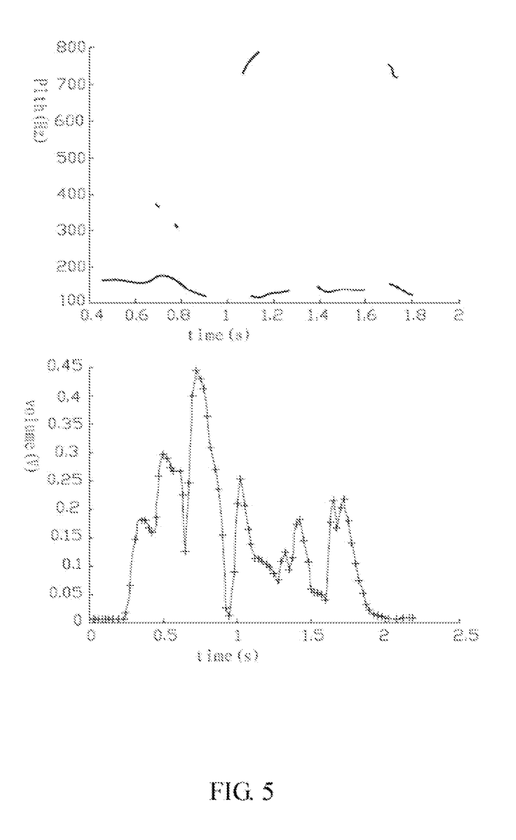

FIG. 5 is a diagram of result of calculating a volume and a pitch of an original audio, according to method described in FIG. 3, showing an example of audio preprocessing but not as limitation to the present disclosure. Hereafter, the target fragment of the watermark loading is chosen based on the preprocessing result showing in FIG. 5.

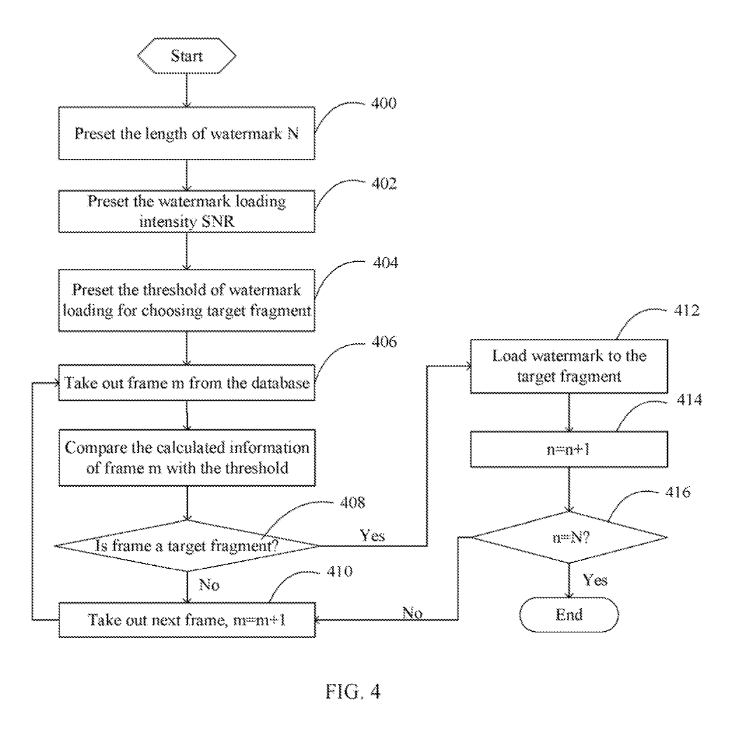

FIG. 4 illustrates a flowchart of one embodiment of loading watermark. The flowchart gives details of blocks 202 and 204 in FIG. 2. In the described embodiment, the method is executed by the units described in FIG. 1.

In blocks 400-404, the configuring unit 1022 receives setting information input by the users and presets the length of the watermark N, the watermark loading intensity

SNR (single-noise-ratio) and the thresholds for target fragment determination according to the setting information received. In detail, the watermark loading intensity refers to a value of SNR of the watermarked audio and the preset value is the minimum value that user can accept. For example, if user expects that the absolute value of SNR of the watermarked audio is larger than 60, the configuring unit 1022 presets SNR=60 dB. In more detail, the thresholds include two threshold value, one is a volume threshold and another is a pitch threshold.

In block 406, the judging unit 1023 gets frame m that stored from the cache in database 1024, here “m” is a measured value of the frame, for example, taking out frame 1 means taking out the first frame of the original audio. When a frame is taken out from the cache in database 1024, the calculated information of the frame is also taken.

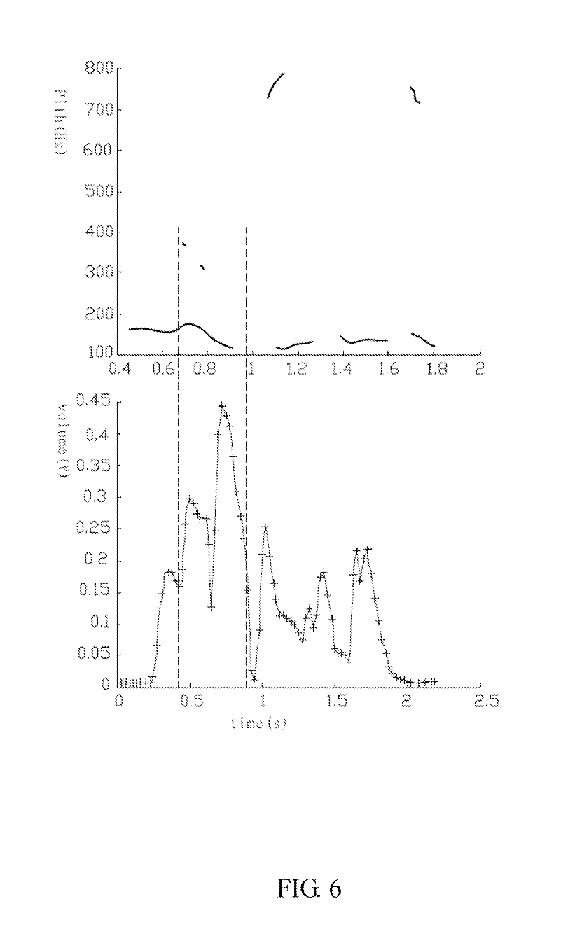

In block 408, the judging unit 1023 compares the calculated information of the first frame with the preset thresholds and determines whether the first frame is the target fragment to load watermark or not. If the first frame is the target fragment, the flowchart goes to block 412. If the first frame is not the target fragment, the flowchart goes to block 410. In detail, in order to hide the watermark, a low-frequency fragment is chosen as target while the fragment is also a high-volume fragment, based on the human auditory masking effect as well as considering the energy of the signal. For example, if the volume threshold is 0.15V and the pitch threshold is 200 Hz, respectively, a frame is determined to be the target fragment when the pitch of the frame of is lower than 200 Hz and the volume of the same frame is greater than 0.15V. For example, FIG. 6 is a diagram of one embodiment of target fragment choosing of the original audio based, in FIG. 6, a fragment whose volume is greater than 0.15V and whose pitch is lower than 200 Hz is chosen as target fragment to load watermark.

In block 410, the judging unit 1023 is ready to take out next frame and measured value of frame m adds 1, then the flowchart goes back to block 406.

In block 412, the judging unit 1023 load watermark for the target fragment according to relevant preset parameters. In detail, the intensity of noise needed when loading the watermark is decided by the preset SNR (watermark loading intensity) and the preset thresholds, which needs to ensure that the value of SNR of watermarked audio reaches the value of the preset SNR. Meanwhile, the value of the volume threshold can be adopted as actual volume of audio when calculating the intensity of noise so that the noise intensity is consistent. Also, Gaussian white noise can be a good choice because it is easy to analyze and easy to extract as well as will not bring too much irregular noise. The watermark is decided by a user, for example, when the watermark is 1, the judging unit 1023 will load Gaussian noise with need intensity into the target from. When the watermark is 0, the judging unit 1023 will not perform any operations on the target fragment.

In block 414, the measured value of length of the watermark n is added 1 when the watermark loading for the target frame (the first frame) is finished.

In block 416, the judging unit 1023 determines whether n is equal to the length of the watermark N. If n is equal to N, the watermark loading for the original audio is finished. If n is smaller than N, the watermark will continue and the flowchart goes back to block 410.

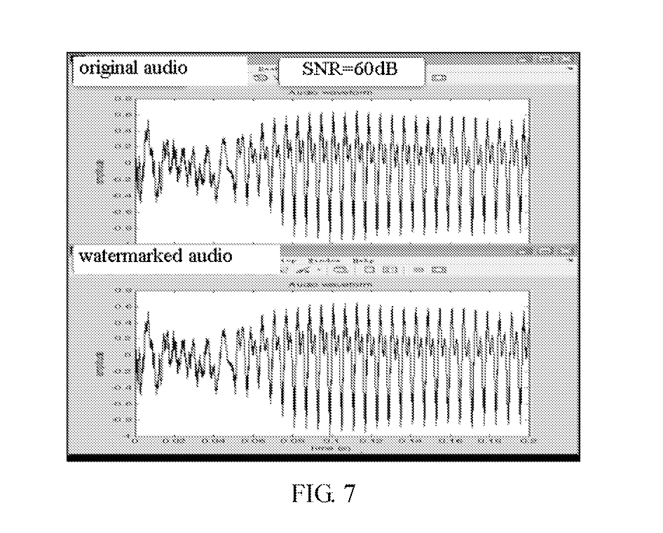

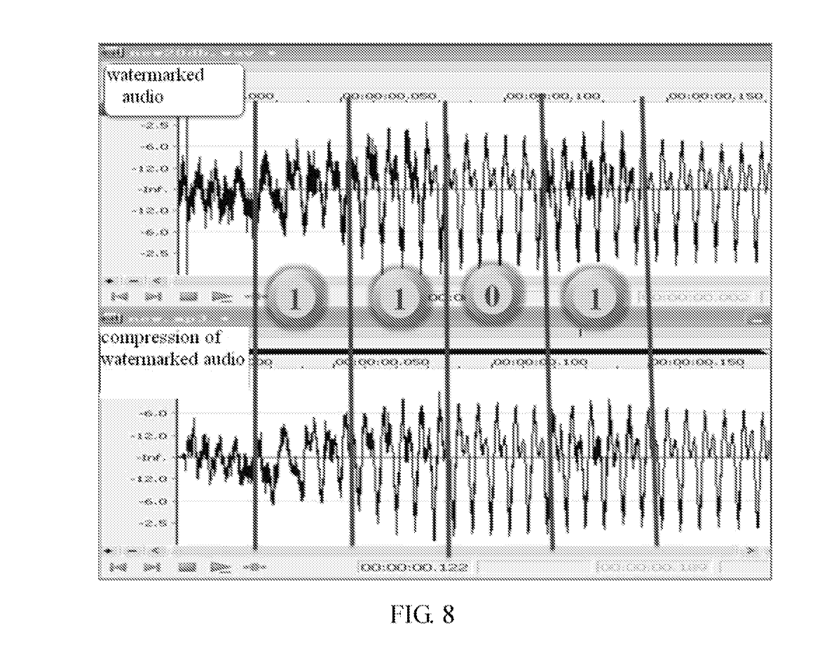

FIG. 7 is a diagram of one embodiment of comparison of audio files before and after watermark loading showing on MATLAB platform according to method of watermark loading described above. Referring to FIG. 8, when the configure unit 1022 configures the value of watermark loading intensity SNR as 60 dB, the watermarked audio has no significant difference comparing to the original audio, which indicates that the watermark has no effect on the original audio and will not affect the quality of the original audio. In addition, FIG. 8 is diagram of one embodiment of comparison of watermarked audio before and after compression showing on MATLAB platform. For the watermark should in FIG. 8, the watermark loaded for each target segment is 1,1,0 and 1 respectively. It is obvious in FIG. 8 that the compression of watermarked audio does not do obvious damage to the watermark and the watermark of the watermarked audio i still retain well after the watermarked audio is compressed. In a word, this method of watermark loading has a strong resistance to compressive interference and has good robust features.

In summary, the watermark loading device 10 and method of watermark loading in the present embodiment of the present disclosure selects fragment of high volume and low pitch to load Gaussian white noise and hides the watermark based on the masking effect. The methods described herein will not affect the quality of the original audio and can have good robust features.

While various embodiments and methods have been described above, it should be understood that they have been presented by way of example only and not by way of limitation. Thus the breadth and scope of the present disclosure should not be limited by the above-described embodiments. The above-described embodiments are illustrative only, and should not be construed as limiting the following claims.

What is claimed is:

1. A watermark loading device that loads a watermark to an original audio, the watermark loading device comprising:
at least one processor;
a storage system; and
one or more programs that are stored in the storage system and are executed by the at least one processor, the one or more programs comprising:
a resolving unit that preprocesses the original audio, calculates a volume and a pitch of the original audio and saves the volume and the pitch as audio information of the original audio;
a configuring unit that configures relevant parameters of watermark loading, wherein the relevant parameters comprise a watermark loading intensity, a volume threshold and a pitch threshold for choosing a target fragment of the original audio; and
a determining unit that compares the audio information with the volume threshold and the pitch threshold to determine the target fragment and loads the watermark to the target fragment according to the watermark loading intensity to get a watermarked audio.

2. The watermark loading device of claim 1, wherein the watermark loading intensity indicates an expected value of signal to noise ratio of the watermarked audio.

3. The watermark loading device of claim 1, wherein the watermark is Gaussian white noise.

4. The watermark loading device of claim 2, wherein the volume of the target fragment is greater than the volume threshold and the pitch of the target fragment is below the pitch threshold.

5. A watermark loading method, comprising:
preprocessing the original audio, calculating a volume and a pitch of the original audio, and saving the volume and pitch as audio information of the original audio;
configuring relevant parameters of watermark loading, wherein the relevant parameters comprise a watermark loading intensity, a volume threshold and a pitch threshold for choosing a target fragment of the original audio that is to be loaded watermark; and
comparing the audio information with the volume threshold and the pitch threshold to determine the target fragment and loading watermark for the target fragment according to the watermark loading intensity to get a watermarked audio.

6. The method of claim 5, wherein the watermark loading intensity indicates an expected value of signal to noise ratio of the watermarked audio.

7. The method of claim 6, wherein the watermark is Gaussian white noise.

8. The method as described in claim 6, wherein the volume of the target fragment is greater than the volume threshold and the pitch of the target fragment is below the pitch threshold.
